(19) United States
(12) Patent Application Publication
(10) Pub. No.: US 2007/0217626 A1
(43) Pub. Date: Sep. 20, 2007

(54) Watermark Synchronization System and Method for Embedding in Features Tolerant to Errors in Feature Estimates at Receiver

(75) Inventors: Gaurav Sharma, Webster, NY (US); David J. Coumou, Webster, NY (US); Mehmet Celik, Eindhoven (NL)

Correspondence Address: BOND, SCHOENECK & KING, PLLC, 10 BROWN ROAD, SUITE 201, ITHACA, NY, 14850-1248, US

(73) Assignee: UNIVERSITY OF ROCHESTER, Rochester, NY (US)

(21) Appl. No.: 11/687,103

(22) Filed: Mar. 16, 2007

Related U.S. Application Data
(60) Provisional application No. 60/783,706, filed on Mar. 17, 2006.

(51) Int. Cl. G06F 17/00

(52) U.S. Cl. 381/100; 700/94

(57) ABSTRACT

The present invention is directed to a system that includes a signal feature estimator module configured to derive a plurality of signal feature estimate values from a received signal. An inner symbol alignment decoder is coupled to the signal feature estimator module. The inner symbol alignment decoder is configured to generate N probability vectors from the plurality of signal feature estimate values using a predetermined marker vector. N is an integer estimate of a number of symbols in a codeword corresponding to an watermark message that may or may not be embedded in the received signal. An outer soft-input error correction decoder is coupled to the inner decoder. The outer decoder performs a series computations and generates an estimated watermark message based on the N probability vectors. The watermark message is used to communicate data and/or to authenticate the received signal.

### CROSS-REFERENCE TO RELATED APPLICATIONS

This application claims priority under 35 U.S.C. §119(e) to U.S. Provisional Patent Application Ser. No. 60/783,706 filed on Mar. 17, 2006, the content of which is relied upon and incorporated herein by reference in its entirety.

### BACKGROUND OF THE INVENTION

1. Field of the Invention

The present invention relates generally to multi-media communications systems, and particularly to a system and method for embedding a digital watermark in a content signal.

2. Technical Background

The term multimedia usually refers to the presentation of video, audio, text, graphics, video games, animation and/or other such information by one or more computing systems. Since the mid-1990's, multimedia applications have become feasible due to both a drop in computer hardware prices and a concomitant increase in performance. In the music recording industry, for example, the technology has progressed from selling physical objects having music recorded thereon, i.e., compact disks and the like, to merely providing music in a digital format via the Internet. However, as a result of the aforementioned technological advances, the protection of intellectual property has become a major issue. The ability of a user to “download” and copy digital content directly from the Internet made copyright enforcement, at least initially, very difficult, if not impossible. In fact, the music recording industry has lost millions of dollars in sales to such unauthorized copying and has recently begun to take an aggressive stance against infringers. What is needed is a system and method for preventing such unauthorized copying.

In one approach that is being considered, copyrights may be protected in the digital domain by the application of what is commonly referred to as a “digital watermark.” In general, a digital watermark is a secondary signal that is embedded in the content signal, i.e., the video, speech, music, and etc., that is not detected by the user during usage. The secondary signal may be used to mark each digital copy of the copyrighted work. The watermark may also be configured to include the title, the copyright holder, and the licensee of the digital copy. The watermark may also be used for other purposes, such as billing, pricing, and other such information. Additional examples of uses of watermarking include authentication and communication of meta-data, often in scenarios where a separate channel is not available for these purposes.

As those of ordinary skill in the art will appreciate, all communication systems require synchronization between the transmitter and the receiver before data transfer can occur. Two types of watermarking systems are typically considered, “oblivious” watermarking systems where the watermark detector must extract the watermark data without access to the original “unwatermarked” image and “non-oblivious” systems where the watermark detector may use the original unwatermarked image in the extraction process. For a number of applications, “oblivious” systems are preferable because they scale better and can be more easily deployed in comparison to “non-oblivious” systems. Combinations of the two are also possible in which the “oblivious” watermark could help identify an unwatermarked original which can then be utilized to extract the “non oblivious” watermark and retrieve additional data. Synchronization is a major issue for “oblivious” watermarking receivers. Receiver synchronization in “non-oblivious” watermarking systems is not a major issue because the receiver has a copy of the original un-watermarked multimedia signal stored in memory. In this instance, the receiver “knows” the multimedia signal in which the watermark was embedded, and using this information, can therefore easily establish a synchronization to aid message recovery. Synchronization in oblivious watermarking systems, i.e., where the receiver does not have a copy of the transmitted message, is a different matter entirely.

After more than a decade of multimedia watermarking development, watermark synchronization remains a vexing issue for watermarking algorithm designers. Synchronization is an essential element of every digital communication system and has been extensively researched in that context. In watermarking/data-hiding applications, however, synchronization poses unusual and particularly challenging new problems because the primary goal in these systems is not the communication of the watermark data but the communication of the multi-media information with minimal or no perceptual degradation. The communication of the embedded data is a secondary objective that, nonetheless, is often required to be robust against signal processing operations that do not significantly degrade perceptual quality. A variety of watermarking schemes have been proposed to facilitate synchronization at the watermark receiver. Typically, methods are designed to be robust against a specific set of operations such as rotation, scaling, and translation, or some combination thereof, and have had varying levels of success.

A number of approaches have been explored for synchronization in oblivious watermarking. Methods presented in the literature can be categorized broadly into two main classes: methods that embed the watermark data in multi-media signal features that are invariant to the signal processing operations, or in regions determined by such features; and methods that enable synchronization through the estimation and (approximate) reversal of the geometric transformations that the multi-media signal has been subjected to after watermark embedding. Approaches in the former category include methods that use the Fourier-Melin transform space for rotation, translation, scale invariance, embed watermarks in geometric invariants such as image moments. Other approaches in this category employ methods that use semantically meaningful signal features, either for embedding or for partitioning the signal space into regions for embedding. Examples of the latter category are methods that repeatedly embed the same watermark, or include a transform domain pilot watermark, explicitly for the purpose of synchronization.

Among these techniques, the methods based on semantic features hold considerable promise since these features are directly related to the perceptual content of the multi-media signal, and therefore, are most likely to be conserved in the face of both benign and malicious signal processing operations. What is needed is a system and method for robust and repeatable extraction of semantically meaningful signal content features. Those of ordinary skill in the art will appreciate that benign processing or a malicious change may cause the receiver to erroneously detect a signal content feature or erroneously delete a signal content feature. Because each signal content feature represents a watermark message bit, such insertions and deletions cause de-synchronization of the watermark channel.

What is needed is a synchronization system and method that compensates for the aforementioned insertions and deletions to thereby prevent receiver de-synchronization of the watermark channel.

SUMMARY OF THE INVENTION

The present invention addresses the needs described above. In particular, the present invention is directed to a synchronization system and method that employs error correction codes to obviate insertions and deletions caused by discrepancies in estimates of features between the watermark embedder and the receiver.

One aspect of the present invention is directed to a system that includes a signal feature estimator module configured to derive a plurality of signal feature estimate values from a received signal. An inner symbol alignment decoder is coupled to the signal feature estimator module. The inner symbol alignment decoder is configured to generate N probability vectors from the plurality of signal feature estimate values using a predetermined marker vector. N is an integer estimate of a number of symbols in a codeword corresponding to an oblivious watermark message that may or may not be embedded in the received signal. An outer LDPC decoder is coupled to the inner decoder. The outer LDPC decoder performs a series of iterative computations up to a predetermined number of iterations. Each iterative computation generates an estimated watermark message based on the N probability vectors. The estimated watermark message is authenticated if and only if the estimated watermark message satisfies a low density parity check within the predetermined number of iterative computations.

In another aspect, the present invention is directed to a system that includes a transmitter sub-system and a receiver sub-system. The transmitter subsystem has an outer LDPC coder configured to encode a watermark signal with a low density parity check such that a codeword having N symbols is generated. A sparsifier module is coupled to the outer coder. The sparsifier module includes a look-up table (LUT) that is configured to map each of the N-symbols to a memory location within the sparsifier LUT to obtain a sparse message vector. An adder is coupled to the sparsifier LUT. The adder is configured to combine the sparse message vector and a marker vector to generate an embedded message. A signal feature embedding module is coupled to a media signal source and the adder. The signal feature embedding module is configured to detect media signal segments based on the signal feature and embed at least one bit of the embedded message into each media signal segment to thereby generate a watermarked media signal.

As noted, the system also has a receiver subsystem that includes a signal feature estimator module configured to derive a plurality of signal feature estimate values from a received signal. An inner symbol alignment decoder is coupled to the signal feature estimator module. The inner symbol alignment decoder is configured to generate N probability vectors from the plurality of signal feature estimate values using a predetermined marker vector. N is an integer estimate of a number of symbols in a codeword corresponding to an oblivious watermark message that may or may not be embedded in the received signal. An outer LDPC decoder is coupled to the inner decoder. The outer LDPC decoder performs a series of iterative computations up to a predetermined number of iterations. Each iterative computation generates an estimated watermark message based on the N probability vectors. The estimated watermark message is authenticated if and only if the estimated watermark message satisfies a low density parity check within the predetermined number of iterative computations.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operation of the invention.

### BRIEF DESCRIPTION OF THE DRAWINGS

FIG. 1 is a block diagram in accordance with the present invention;

FIG. 2 is a diagrammatic depiction of insertion, deletion, and substitution events;

FIG. 3 is a block diagram of a features based watermarking system with synchronization in accordance with an embodiment of the present invention;

FIG. 4 is a flow chart illustrating a method for embedding a watermark signal in a multimedia content signal in accordance with an embodiment of the present invention;

FIG. 5 is a detailed block diagram of the watermark coding mechanism in accordance with an embodiment of the present invention;

FIG. 6 is a diagrammatic depiction of an IDS channel hidden Markov model;

FIG. 7 is a block diagram of a system implementation in accordance with another embodiment of the present invention;

FIG. 8 is a diagrammatic depiction illustrating one application of the present invention;

FIG. 9 is a diagrammatic depiction illustrating another application of the present invention;

FIG. 10 is a diagrammatic depiction illustrating yet another application of the present invention;

FIG. 11 is a detailed block diagram of a speech watermark system in accordance with another embodiment of the present invention;

FIG. 12 is a detail diagram showing data embedding in speech by pitch modification in accordance with the embodiment depicted in FIG. 11;

FIG. 13 is a detail diagram showing extraction of data embedded in speech by pitch modification in accordance with the embodiment depicted in FIG. 11;

FIG. 14 is a chart showing the differences between inserted and extracted bits in the absence of synchronization; and

FIG. 15 is a chart showing LDPC iteration count vs. the number of errors for the outer counter.

### DETAILED DESCRIPTION

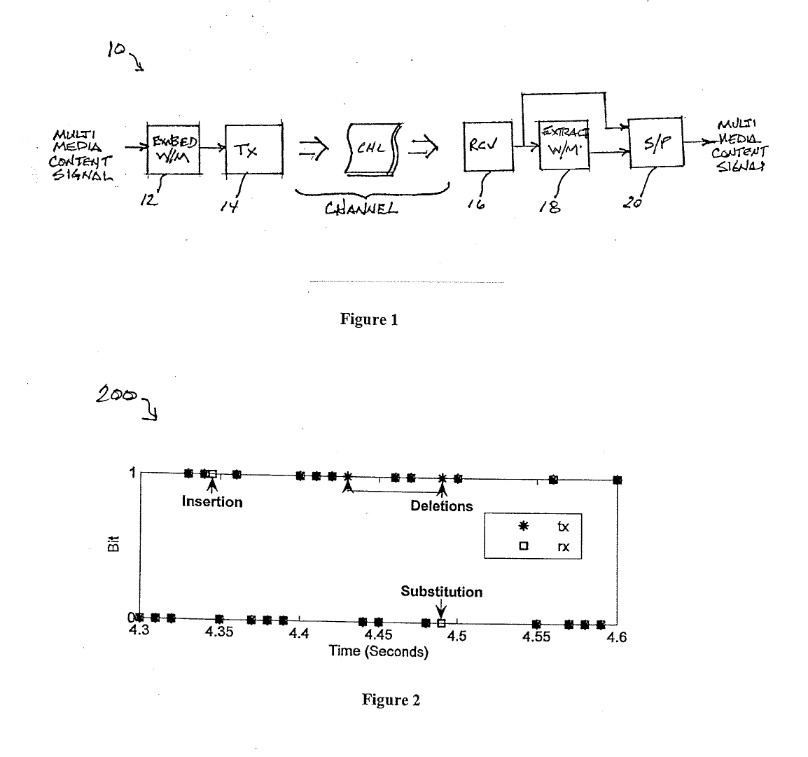

Reference will now be made in detail to the present exemplary embodiments of the invention, examples of which are illustrated in the accompanying drawings. Wherever possible, the same reference numbers will be used throughout the drawings to refer to the same or like parts. An exemplary embodiment of the watermarking system of the present invention is shown in FIG. 1, and is designated generally throughout by reference numeral 10.

As embodied herein and depicted in FIG. 1, a very general block diagram of the watermarking system 10 in accordance with the present invention is disclosed. Essentially, a multimedia signal is directed into encoder 12, which is configured to embed a watermark therein by using a selected signal feature, or by using signal regions interposed between the signal features. Subsequently, the watermarked signal is directed into a transmitter and the signal propagates in the channel. The receiver 16 may be configured to demodulate the signal and perform further signal processing operations, such as data decompression and the like. At this point, the watermarked signal is directed into the watermark decoder of the present invention for authentication. If processing block 18 authenticates or validates the message, the multimedia signal may be directed into signal processing block 20 and provided to the far-end user in an accustomed format. For example, if the signal is a music file, the signal processing component 20 will convert the signal into an analog signal which will be converted into sound waves by a speaker system.

It will be apparent to those of ordinary skill in the pertinent art that modifications and variations can be made to the selected signal feature depending on the nature of the signal itself. For example, if the signal is video signal the selected signal feature may be a corner. On the other hand, if the media signal is a speech signal, for example, the signal feature may be pitch, or regions between pseudo-periodic signal segments. Those of ordinary skill in the art will understand that the present invention may be employed using any multimedia signal as long as a suitable signal feature is selected.

It will also be understood by those of ordinary skill in the art that the propagation channel may be configured to support electrical signals via wire or coaxial cable, electromagnetic signals such as wireless telephony signals, optical signals, optical signals propagating by way of fiber optic transmission components, acoustic signals, and/or any suitable transmission means.

Referring to FIG. 2, the key issues related to the use of signal features for embedding watermark signals are insertion, deletion and substitution events generated during, receiver estimates of the number of signal features in a received signal. In other words, the estimated number of signal features (and therefore, the estimated number of watermark signal bits) may differ from the number of signal features actually transmitted. Deletions may occur when multiple signal segments encoded during the transmission process may coalesce into a single signal segment at the receiver, or vice versa. Further, some signal features may not be detected by the receiver. The receiver may also “detect” signal features that do not have information embedded therein. The receiver may also substitute a “one” for a “zero” and vice-versa. These types of errors may be referred to as insertion, deletion, and substitution (IDS) errors in the estimates of the embedded data. Insertion/deletion events are particularly insidious because they result in a loss of synchronization. IDS errors cannot be corrected using conventional error correction codes.

FIG. 2 is an example illustration of insertion deletion, and substitution (IDS) events in a receiver system. A time interval compares encoded and transmitted bits (* “star” symbols) with received and decoded, i.e., extracted bits (□ “square” symbols). Time locations with overlapping star and square symbols correspond to instances where embedded and extracted bits match. Thus, the plot shows that synchronism is not maintained between the embedded and extracted bits. Locations where both are present but the bit values do not match are referred to as substitution events. A deletion event is shown in FIG. 2 by the occurrence of a star symbol without a corresponding square symbol being present. An insertion event relates to the insertion of a spurious bit in the received stream, and therefore, is represented by squares without corresponding stars. The plot of FIG. 2 illustrates a scenario wherein there are one insertion, two deletions, and one substitution event.

Those of ordinary skill in the art will understand that both insertions and deletions will effect a de-synchronization of the receiver relative to the transmitter. Accordingly, the embedded watermark signal will not be properly decoded and authenticated by the receiver. The present invention addresses this problem by incorporating concatenated coding techniques that synchronize and recover data propagating over IDS channels.

Referring to FIG. 3, in accordance with one embodiment of the present invention, a system block diagram 10 for a signal features based watermarking system with synchronization is disclosed. The present invention includes a data embedding/extraction portion 300 and a synchronization/en-or recovery portion 310. The transmitter includes an encoder 312 disposed in synchronization portion 310. The encoder 312 provides a watermarking signal t to the data embedding module 302. Data embedding module 302 embeds signal data t in the signal through modifications of signal features in the multimedia signal. At the receiving end, data extraction component 304 extracts an estimate the data signal \hat{t} through the estimation of the signal features. Distortions that are introduced in the channel (or even in the embedding process itself) may cause extracted data \hat{t} to differ from the data signal t provided by the transmitter. The synchronization/error recovery block mitigates the effects of these errors and prevents de-synchronization from occurring.

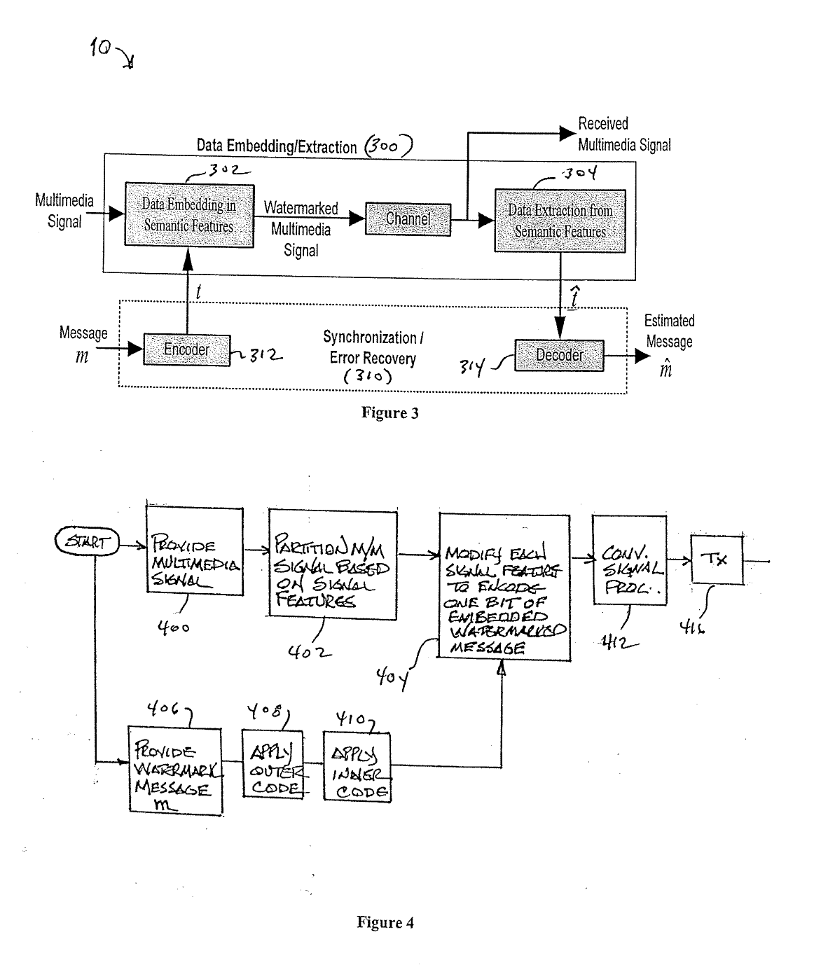

FIG. 4 is a flow chart that provides a high-level overview of the process for embedding an encoded watermark signal in a multimedia signal, using semantic features from the multimedia signal itself. In step 400, a multimedia signal is provided to the transmitter portion of system 10. In step 402, the signal is partitioned based on a recognizable predetermined semantic feature type. For example, the semantic feature type might be speech pitch, an image centroid, image corner or any suitable semantic feature. Thus, the signal may be thought of as a series of concatenated signal segments, wherein each signal segment is characterized by a semantic feature of the predetermined type.

At the same time system 10 is partitioning the multimedia signal based on semantic features, a watermarking message is provided to encoder 312. Encoder 312 is a concatenated encoder that includes an inner encoder and an outer encoder (See FIG. 5). Accordingly, in step 408, the watermark signal is directed into an outer encoder. In one embodiment of the present invention, the outer encoder may be implemented using a low-density parity-check (LDPC) encoder. The outer coded signal is then directed into an inner coder.

In step 404, the encoded watermarking signal is embedded into the multimedia signal. In particular, the encoded watermark signal is applied to the multi-media content signal by modifying each occurrence of the recognizable signal feature by a predetermined modulation to thereby encode one bit of the encoded watermark message. In step 412, the transmitter may perform conventional signal processing tasks. Finally, the transmitter directs the signal into the propagation channel.

Referring to FIG. 5, a detailed block diagram of the watermark encoding/decoding system in accordance with an embodiment of the present invention is shown. Following the convention employed in FIG. 1, the system includes a transmitter sub-system including the watermark embedding module 12 and transmitter 14 and a receiver sub-system that includes receiver 16 and watermark authentication portion 18.

The transmitter subsystem has an outer LDPC coder 120 configured to encode a watermark message signal m with a low density parity check. The message in is includes K “q-ary” symbols, with q=2^{k} for some value of k. The LDPC encoder 120 encodes message m using a rate K/N q-ary LDPC code to generate a codeword “d” having N q-ary symbols. The LDPC code is specified by a sparse (N−K)×N parity check matrix H, having entries selected from GF(q), i.e., a Galois Field having q=2^{k} elements. A sparsifier module 122 is coupled to the LDPC encoder 120. The sparsifier module 122 includes a look-up table (LUT) that is configured to map each of the N-symbols to a memory location within the sparsifier LUT to obtain a sparse message vector. The LUT includes q=2^{k} entries of sparse n-bit code vectors. An adder is coupled to the sparsifier LUT. The adder is configured to combine the sparse message s vector and a marker vector w to generate an embedded watermark signal t comprising the modulo-2 sum of s and w. The sparse vector and the marker vector have the same number of bits. A signal feature embedding module 128 is coupled to a media signal source and the modulo-2 adder 126. The signal feature embedding module 128 is configured to detect media signal segments based on the signal feature and embed at least one bit of the embedded message t into each media signal segment to thereby generate a watermarked media signal x.

Note that the synchronization marker vector w, which is a fixed (preferably pseudo-random) binary vector of length N, i.e., N symbols times n bits, is independent of the message data m, and known to both the transmitter and receiver. It forms the data embedded at the transmitter when no (watermark) message is to be communicated. In the absence of any substitutions, knowledge of this marker vector allows the receiver to estimate insertion deletion events and thus regain synchronization (with some uncertainty).

Message data to be communicated is “piggy-backed” onto the marker vector. This is accomplished by mapping the message to a unique sparse binary vector via a codebook, where a sparse vector is a vector that has a small number of 1's in relation to its length. The sparse vector is then incorporated in the synchronization marker prior to embedding, as intentional (sparse) bit-inversions at the locations of 1's in the sparse vector. Conceptually, once the receiver synchronizes, since the synchronization marker vector is known to the receiver, bit-inversions in the marker vector can be determined. If the channel does not introduce any substitution errors, these bit-inversions indicate the locations of the 1's from the sparse vector and allow recovery of both the sparse vector and the watermarking message. With the addition of channel induced substitutions, the accuracy of the receiver estimate of the sparse vector is uncertain. This uncertainty is resolved by the outer q-ary LDPC code. The q-ary codes offer a couple of benefits over binary codes. First, suitably designed q-ary codes with q≧4 offer performance improvements over binary codes, even for channels without insertions/deletions. Second, the q-ary codes provide improved rates specifically for the case of IDS channels.

For simplicity's sake, only the transmission of a single message block is considered in the following discussion of FIG. 5. The watermark message data m is a block of K q-ary symbols (with q=2^{k} for some k). The message m is encoded (in systematic form) using a rate KIN q-ary LDPC code to obtain codeword d, which is a block of N q-ary symbols. The LDPC code is specified by a sparse (N−K)×N parity check matrix H with entries selected from GF(q). The rate k/u sparsifier maps each q-ary symbol into an n-bit sparse vector using a look-up table (LUT) containing q=2^{k} entries of sparse u-bit vectors. Thus corresponding to the codeword d there are (Nn) bits that form the sparse message vector s that is added to the marker vector w (of the same length). The overall rate of the concatenated system is (Kk)/(Nn) message bits per bit communicated over the IDS channel (i.e. per embedded bit).

Referring to the receiver subsystem, receiver 16 is configured to derive received signals from signals propagating in a communication channel. The receiver is coupled to signal feature estimator module 180. The estimator module 180 is configured to detect signal features and derive a signal feature estimate values from the received signal. The estimate values form an estimated embedded message \hat{t}. An inner symbol alignment decoder 184 is coupled to the signal feature estimator module 180. The inner symbol alignment decoder 184 is generates N probability vectors from the plurality of signal feature estimate values using the marker vector w. This, of course, is the reverse process of the sparsifier module 122 in the transmitter. The N probability vectors in output P(d) correspond to the N code words in codeword d. Of course, the notation P(d) is employed because P(d) provides symbol-by-symbol likelihood probabilities for each of the N symbols corresponding to an oblivious watermark message that may or may not be embedded in the received signal. However, if a watermark signal is embedded therein, the N symbol-by-symbol likelihood probabilities provide receiver/transmitter symbol alignment, i.e., synchronization.

An outer LDPC decoder 186 is coupled to the inner decoder 184. The outer LDPC decoder 186 performs a series of iterative computations. As noted in more detail below, each iterative computation uses the sum-product algorithm to estimate marginal posterior probabilities and provide an estimated watermark message. Each iteration uses message passing to update previous estimates. The estimated watermark message is authenticated if and only if the estimated watermark message satisfies a low density parity check. If a maximum number of iterations is exceeded, a decoder failure occurs.

The system of the present invention implements the concatenated coding scheme developed by Davey and MacKay and employs an outer q-ary LDPC code and an inner sparse code, combined with a synchronization marker vector. Reference is made to M. C. Davey and D. J. C. Mackay, “Reliable communication over channels with insertions, deletions, and substitutions,” IEEE Trans. Info. Theory, pp. 687-698, Feb. 2001, which is incorporated herein by reference as though fully set forth in its entirety, for a more detailed explanation of an outer q-ary LDPC code and an inner sparse code combined with a synchronization marker vector.

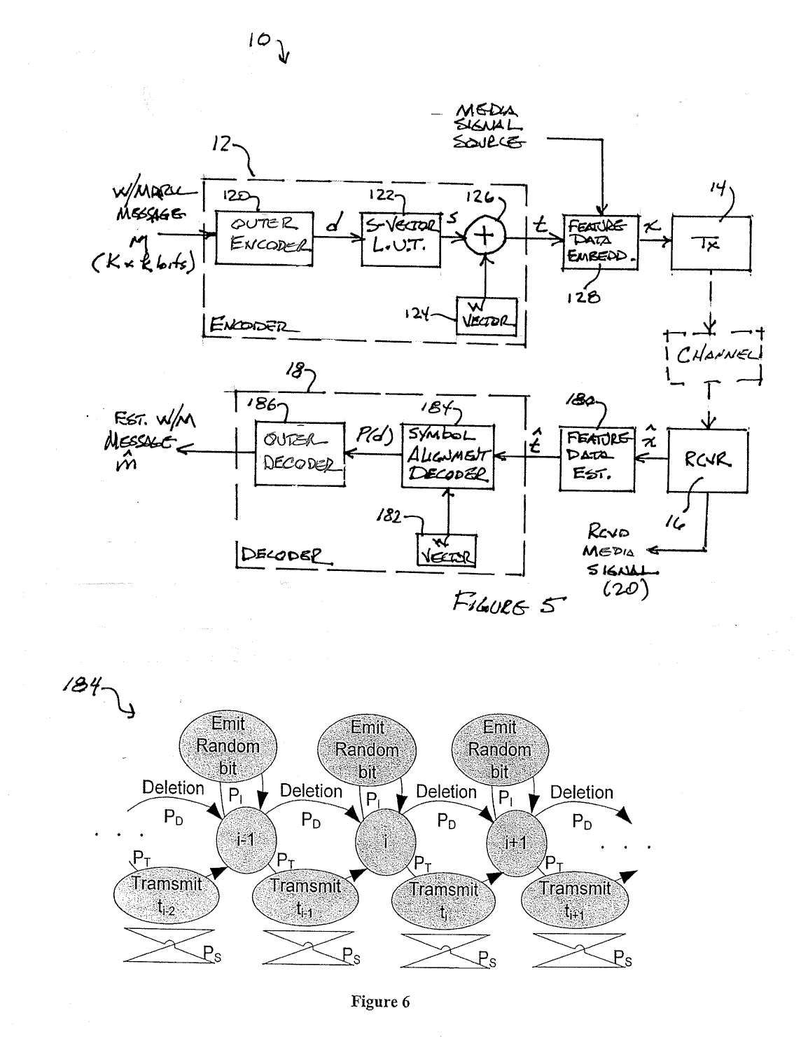

Referring to FIG. 6, the soft inner decoder 184 implements the hidden Markov model for the channel, to efficiently compute symbol-by-symbol likelihood probabilities P(dᵢ)=P(\hat{t}|dᵢ, h̅) for 1≦i≦N, where h̅=( h̅′, w) represents the known information at the receiver. Note that since the symbols comprising d are in fact q-ary, P(dᵢ) is a probability mass function (pmf) over all the q possible values of dᵢ. These pmf's, form the (soft) inputs to the outer LDPC iterative decoder. The computations in the inner decoder are performed using a forward-backward procedure for HMM corresponding to IDS Channel' followed by a combination step for the HMM for IDS Channel. Note that h̅′ refers to probabilities known by the receiver. Consider that the states ( . . . i−1, i, i+1) represent the (hidden) states of the model, where state i represents the situation where we are done with the (iₜₕ bit t₍ᵢ₋₁₎ at the transmitter and poised to transmit the i^{th} bit tᵢ. Consider the channel in state i. One of three events may occur starting from this state: 1) with probability Pᵢ, a random bit is inserted in the received stream and the channel returns to state i; 2) with probability P_{T}, the i^{th} bit tᵢ is transmitted over the channel and the channel moves to state (i+1); and 3) with probability PD, the i^{th} bit tᵢ is deleted and the channel moves to state (i+1). When a transmission occurs, the corresponding bit is communicated to the receiver over a binary symmetric channel with cross-over probability P_{S}. A substitution (error) occurs when a bit is transmitted but received in error. The probabilities P_{I}, P_{T}, P_{D}, and P_{S} constitute the parameters for the HMM, which are collectively denote as h̅′. Note that two versions of the model are used corresponding to the blocks labeled IDS Channel and IDS Channel' in FIG. 5. For the latter, the substitution probability is increased suitably to account for the additional substitutions caused by the message insertion.

In an alternative embodiment of the present invention, a Viterbi algorithm could be utilized to determine a maximum likelihood sequence of transitions corresponding to the received vector. Any suitable symbol alignment and synchronization process may be employed herein.

With regard to the Outer Decoder 186, the symbol-by-symbol probability-mass-function vectors P(d)={P(dᵢ)}ᵢ₌₀^{N-1} obtained from the (soft) inner decoder 184 are the inputs for the outer q-ary LDPC decoder. The LDPC decoder 186 is a probabilistic iterative decoder that uses the sum-product algorithm to estimate marginal posterior probabilities P(dᵢ|\hat{t},H) for the codeword symbols {dᵢ}ᵢ₌₀ⁱ⁻¹. Each iteration uses message passing on a graph for the code (determined by H) to update estimates of these probabilities. At the end of each iteration, tentative values for these symbols are computed by picking the q-ary value xᵢ for which the marginal probability estimate P(dᵢ|\hat{t},H) is maximum. If the vector of estimated symbols x=[x₀, . . . , x_{N-1}] satisfies the LDPC parity check condition Hx=0, the decoding terminates and the message m is determined as the first K symbols of x. If the maximum number iterations are exceeded without a valid parity check a decoder failure occurs.

There are a couple of benefits obtained by using q-ary codes in the present invention as opposed to binary codes. First, insertion/deletion events introduce uncertainty around the locations where they occur. Grouping k binary symbols into a q-ary symbol also functions to group the uncertain regions into q-ary symbols. This has the effect of reducing the number of symbols over which the uncertainty is distributed, thereby offering improved performance. This advantage of q-ary codes is similar to the advantage they offer in correcting burst errors, commonly exploited in Reed-Solomon codes. Second, a large value of n is desirable in order to design a more effective sparsifier and to obtain better estimates of the symbol-by-symbol likelihood probabilities P(dᵢ). However, increasing n reduces the overall information rate (Kk)/(Nn). Using a q-ary code allows us to compensate for this by increasing k in comparison to a binary code (for which k=1).

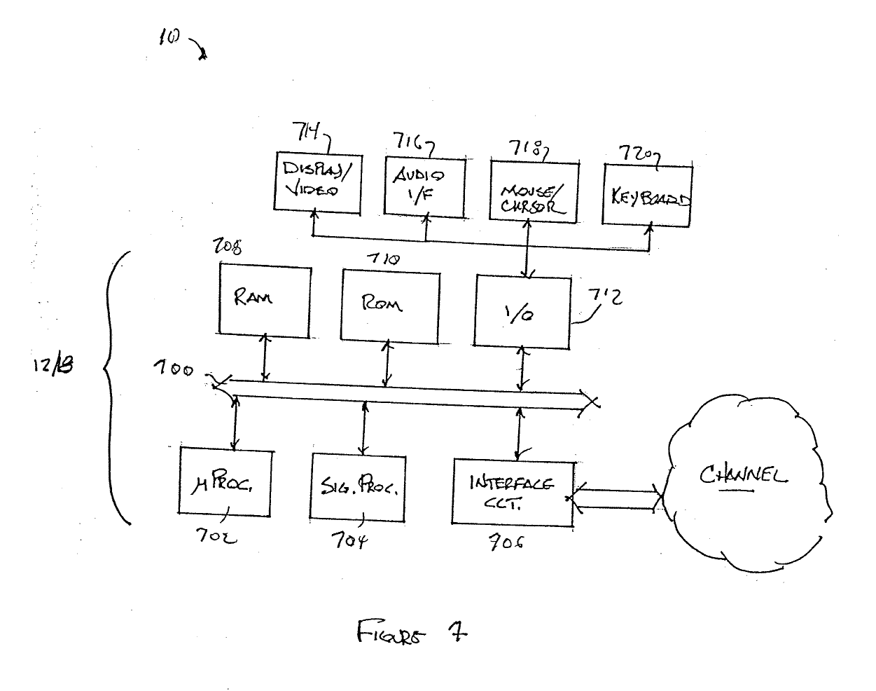

FIG. 7 is a block diagram of a system implementation in accordance with one embodiment of the present invention. System 10 may include a general purpose microprocessor 702, a signal processor 704, RAM 708, ROM 710, and I/O circuit 712 coupled to bus system 700. System 10 includes a communications interface circuit 706 coupled to the communications channel and bus system 700. Those of ordinary skill in the art will understand that, depending on the application and the complexity of the implementation, one or more of the components shown herein may not be necessary. Those of ordinary skill in the art will also understand the encoder/decoder (codec) of the present invention may be implemented in software, hardware, or a combination thereof. Accordingly, the functionality described herein may be executed by the microprocessor 702, the signal processor, and/or one or more hardware circuits disposed in communications interface circuit 706.

In some system implementations, the I/O circuit may support one or more of display system 714, audio interface 716, mouse/cursor control device 718, and/or keyboard device 720. The audio interface 716, for example, may support a microphone and speaker headset, and/or a telephonic device for full-duplex voice communications.

The random access memory (RAM) 708, or any other dynamic storage device that may be employed, is typically used to store data and instructions for execution by processors 702, 704. RAM may also be used to store temporary variables or other intermediate information used during the execution of instructions by the processors. ROM 710 may be used to store static information and the programming instructions for the processors. Those of ordinary skill in the art will understand that the processes of the present invention may be performed by system 10, in response to the processors (702, 704) executing an arrangement of instructions contained in RAM 708. These instructions may be read into RAM 708 from another computer-readable medium, such as ROM 710. Execution of the arrangement of instructions contained in RAM 708 causes the processors to perform the process steps described herein. In alternative embodiments, hard-wired circuitry may be used in place of or in combination with software instructions to implement the embodiment of the present invention. Thus, embodiments of the present invention are not limited to any specific combination of hardware circuitry and software.

Communication interface 706 may provide two-way data communications coupling system 10 to a computer network. For example, the communication interface 706 may be implemented using any suitable interface such as a digital subscriber line (DSL) card or modem, an integrated services digital network (ISDN) card, a cable modem, a telephone modem, or any other such communication interface to provide a data communication connection to a corresponding type of communication line.

As another example, communication interface 706 may be implemented by a local area network (LAN) card (e.g. for Ethernet™ or an Asynchronous Transfer Model (ATM) network) to provide a data communication connection to a compatible LAN.

Communications interface 706 may also support an RF or a wireless communication link. In any such implementation, communication interface 706 may transmit and receive electrical, electromagnetic, or optical signals that carry digital data streams representing various types of information. Further, the communication interface may include peripheral interface devices, such as a Universal Serial Bus (USB) interface, a PCMCIA (Personal Computer Memory Card International Association) interface, etc. Although a single communication interface 706 is depicted in FIG. 7, multiple communication interfaces may also be employed.

Communications interface 706 may provide a connection through local network to a host computer. The host computer may be connected to an external network such as a wide area network (WAN), the global packet data communication network now commonly referred to as the Internet, or to data equipment operated by a service provider.

Transmission media may include coaxial cables, copper wire and/or fiber optic media. Transmission media may also take the form of acoustic, optical, or electromagnetic waves, such as those generated during radio frequency (RF) and infrared (IR) data communications.

The present invention may support all common forms of computer-readable media including, for example, a floppy disk, a flexible disk, hard disk, flash drive devices, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

In the embodiment depicted in FIG. 7, the I/O circuit is coupled to user interface devices such as display 714 and audio card 716. Clearly, the processor 702 will directed the media signal to the user outputs (714, 716) only if the received signal is authenticated. In other words, the system will provide an audio/video output if the estimated watermark message satisfies the low density parity check within the predetermined number of iterative computations. However, it will not provide an output if the estimated watermark message does not satisfy the low density parity check within the predetermined number of iterative computations. In the latter case, the processor 702 may provide an alarm message to the user via the display, indicating that the received signal was not authenticated.

Referring to FIG. 8, another non-limiting example of one possible application of the present invention is disclosed. In this example, one or more users 802 are coupled to a source of gaming e-files 804, a source of audio e-files 806, an Internet Service provider 808, and a source of video e-files by way of network 812. Of course, those of ordinary skill in the art that network 812 may be a LAN, WAN, the Internet, a wireless network, a telephony network such as the Public Switch telephone Network (PSTN), an IP protocol network, or a combination thereof, depending on the application and implementation. User 802 is coupled to the network 812 via an interface. In one embodiment, the interface may be a cable modem provided by ISP 808. The interface may also support fiber optic communications as well as wireless communications. User 802 is shown as having a television 822, a stereo sound system 824, a computing device 826, and a telephone coupled to interface 820. Accordingly, user 802 may retrieve gaming files, video files, audio files and other such data via network 812. As those of ordinary skill in the art will appreciate, the present invention may be implemented in the ISP, interface 820, and/or any of the user components 822-828.

Again, system 800 will provide an audio/video output if the estimated watermark message satisfies the low density parity check within the predetermined number of iterative computations. However, it will not provide an output if the estimated watermark message does not satisfy the low density parity check within the predetermined number of iterative computations. In the latter case, system 800 may provide an alarm message to the user using an appropriate output device.

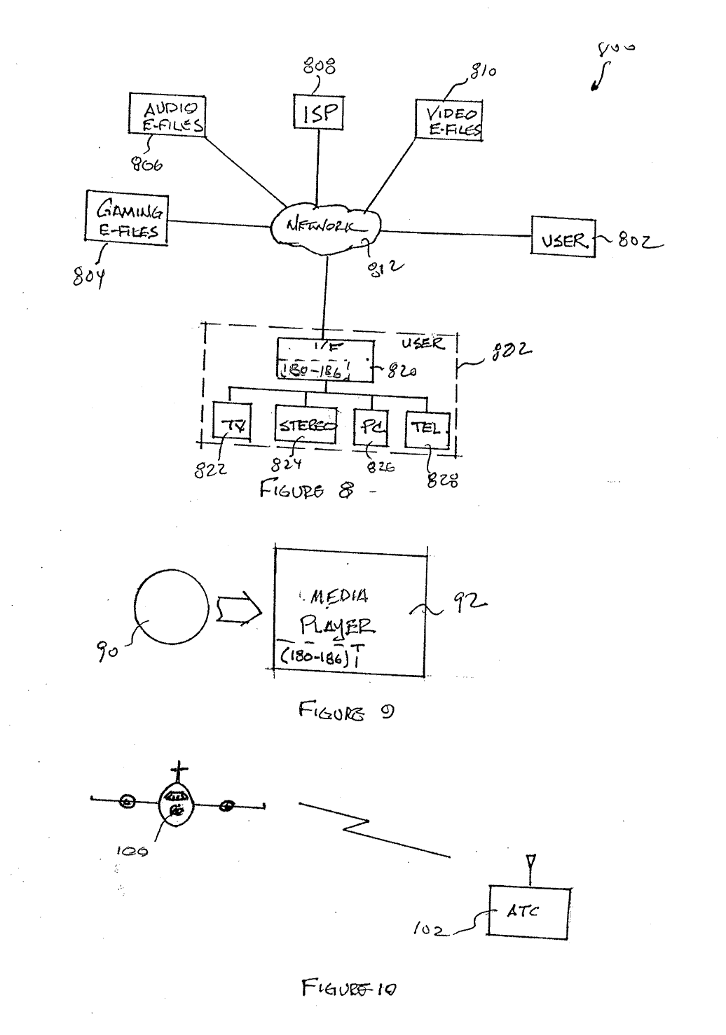

FIG. 9 another non-limiting example of a possible application of the present invention. In this implementation, a user attempts to play a computer readable medium 90 by inserting the medium into player 92. Obviously, if the medium is an authentic article, i.e., not a “bootlegged” article, the signal content is encoded using the methods described herein by the manufacturer. Accordingly, player 92 functions as the receiver. If the watermark is not extracted by the player 92, it will not provide the user with the multimedia signal content, or notify the user that the media is not authentic.

FIG. 10 a yet another non-limiting example of one possible application of the present invention. In this scenario, an aircraft 100 is communicating with air traffic control (ATC) 102 using voice communications. The method and system of the present invention may be implemented in both the aircraft 100 and the ATC facility 102 to authenticate communications.

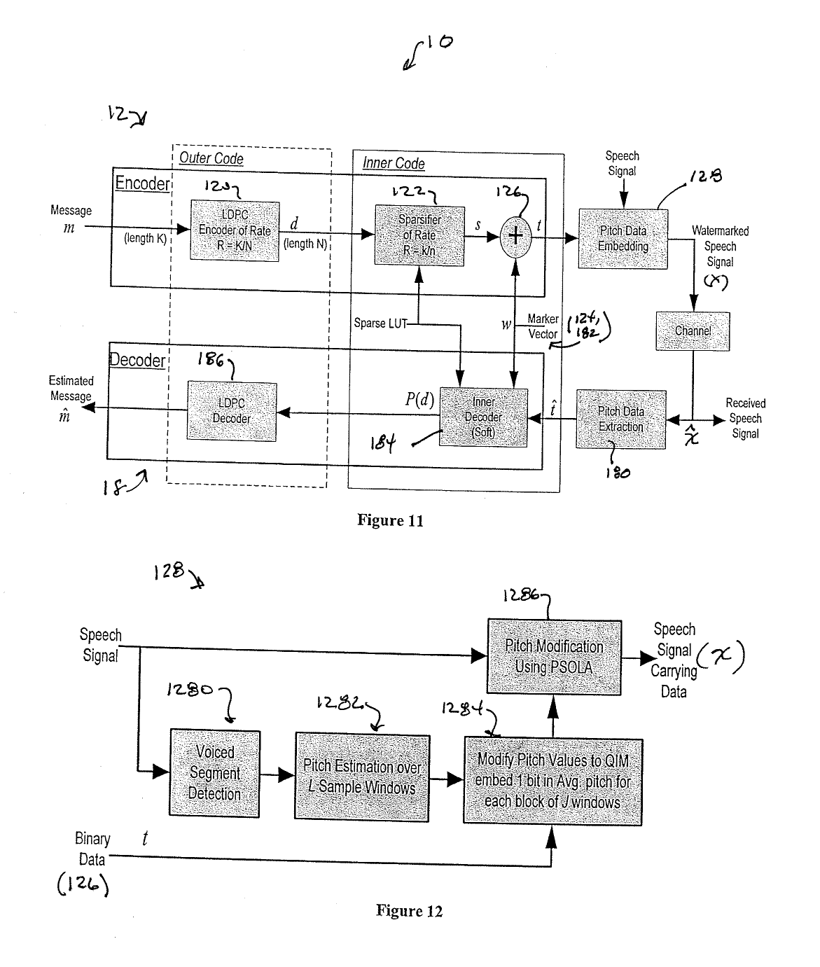

As embodied herein and depicted in FIG. 11, a detailed block diagram of a speech watermark system in accordance with another embodiment of the present invention is disclosed. In this non-limiting example, a complete system showing both the speech data embedding and the concatenated coding system for recovering from IDS errors is shown. Except for the channel, the individual elements of the system have been previously described. The system operates in a channel consisting of low-bit rate voice coders.

The first process performed by the concatenated watermark encoder 12 is to encode the q-ary message m of length K with a low density parity check (LDPC) matrix H. The LDPC encoder 120 concatenates the LDPC check bits with m to yield an output code d of length N. The q-ary symbols in message code d are mapped into sparse binary vectors of length n (n>k=log₂(q)) by sparsifier 122. The mean density of the sparse vectors is f. The sparse code s of sparse binary vectors is added, modulo 2, by adder 126 to the mark vector w to yield t. The overall coding rate is the product of the LDPC encoder 120 and the sparse coding rate. The mark vector w may be formed as a pseudo random or random run length sequence. As an aside, the watermark decoder 18 knows both the mean density of the sparse binary vectors of the mark vector w. These are used by the watermark decoder 18 to synchronize the received data. This is the only á priori information known by the receiver.

In this non-limiting example, the pitch embedding module 128 embeds each bit of the embedded watermark signal t into the pitch waveform. The watermarked speech is not perceivable by the human auditory system. After watermarking, the speech file may be distributed and subjected to conventional speech processing operations such as compression before being transmitted and/or stored.

On the receiver side, the pitch extraction module 180 removes the noisy binary data t′ from the pitch waveform extracted from the received signal. The actual length of each received vector t′ varies according to the number of insertions and deletions. Further, some of the bits of t′ may also be transposed because of substitution errors. The inner decoder 184 attempts to identify the position of synchronization errors in t′.

Inner decoder 184, in the manner previously described, implements an HMM, using as H̅ model parameters, the probabilities of insertions, deletions and substitutions of the channel, the mean density of the sparse binary vectors and the marker vector w. The marker vector w helps localize synchronization errors. Local translations may be identified using the sparse binary vectors. The HMM implemented in inner decoder 184 estimates the model transitions for P(t′|dᵢ, H̅) to produce N likelihood functions [P(d)], one for each symbol.

The N likelihood functions [P(d)] are directed into LDPC decoder 186. LDPC decoder 186 employs a probabilistic and iterative algorithm via belief propagation to produce the estimated message \hat{m}. Belief propagation iterations continue until the syndrome check is valid, i.e. H\hat{m}=0, or the predetermined number of iterations expire. The PSOLA algorithm is employed to synthesize the watermarked speech waveform. The process is repeated for the watermark extraction.

One embodiment of the present invention takes advantage of embedding the watermarking message into pitch sections of length N=5, which enabled a speech watermark embedding rate of approximately 5 bits per second. Watermark encoding rate is dependent on the rate of speech. Efficacy of the concatenated watermark coding scheme was demonstrated with the lowest bit rate compression for adaptive multi-rate coding (AMR) and the Global System for Mobile Communications encoder GSM 6.1. More importantly, the concatenated watermark coding scheme proved to be robust to insertion and deletion rates as high as 7%.

Referring to FIG. 12, a detail block diagram of the pitch embedding module 128, as depicted in FIG. 11, is disclosed. This is an example of data embedding in speech by pitch modification.

Those of ordinary skill in the art will understand that most languages, including English, can be described in terms of a set of distinctive sounds, or phonemes. The phonemes may be divided into two broad classes for the purposes of this discussion. The first group comprises of quasi-periodic sounds, such as vowels, diphthongs, semivowels and nasals. These phonemes show periodic signal structures. The second group comprises of the rest of the phonemes, i.e. stops, fricatives, whisper and affricates. These possess no apparent periodicity. The periodicity of the phonemes in the first group is known as the fundamental frequency or the pitch period. The pitch period of a speech segment is affected by two conditions, the physical characteristics of the speaker (e.g. gender, build, etc.) and the relative excitement of that speaker. Similarly, the duration of these phonemes also vary with the accent, intonation, tempo and excitement of the speaker.

In this embodiment, the pitch of voiced regions of a speech signal are employed as the “semantic” feature for data embedding. The selection of pitch in speech systems for the selected semantic feature is motivated by the fact that most speech encoders ensure that pitch information is preserved. Voiced segments are identified in the speech signal as regions having energy above a threshold and exhibiting periodicity. Within these voiced segments, the pitch is estimated by analyzing the speech waveform and estimating its local fundamental period over non-overlapping analysis windows of L samples each. Data is embedded by altering the pitch period of voiced segments that have at least M contiguous windows. M is experimentally selected to avoid small isolated regions that may erroneously be classified as voiced. Within each selected voice segment one or more bits are embedded. A single bit is embedded by quantization index modulation (QIM) of the average pitch value. For multi-bit embedding, the voiced segment is partitioned into blocks of J contiguous analysis windows (J≦4) and a bit is embedded by scalar QIM of the average pitch of the corresponding block.

Specifically, the average pitch for a block may be computed as:

$${p}_{avg} = \frac{1}{J} {\sum }_{i = 1}^{J} {p}_{i}$$

where {pᵢ}ᵢ₌₁^{J} are the pitch values corresponding to the analysis windows in the block. Scalar QIM is applied to the average pitch for the block, wherein:
p′_{avg}=Q_{b}(p_{avg})

where b is the embedded bit and Q_{b}( ) denotes the corresponding quantizer.

Modified pitch intervals for the analysis windows in the block are computed as:
p′ᵢ=pᵢ+(p′_{avg}−p_{avg})

PSOLA is a simple and effective method for modifying the pitch and duration of quasi-periodic phonemes. It was first proposed as a tool for text-to-speech (TIS) systems that form the speech signal by concatenating pre-recorded speech segments. A speech signal is first parsed for different elementary units (diphones) that start and end with a vowel or silence. During synthesis, various units are concatenated by overlapping the vowels to form words and phrases. In the TTS application, it is often necessary to match the pitch period of two units before concatenation. Moreover, the duration of the vowel is modified for better reproduction.

The corresponding pitch modifications are then incorporated in the speech waveform using the pitch synchronous overlap add (PSOLA) algorithm. Note that the embedding in average pitch values over blocks of analysis windows enables embedding even when the pitch period exceeds the duration of a single window and also reduces perceptibility of the changes introduced. The use of multiple embedding blocks within a voiced segment (of J analysis windows) ameliorates data capacity as compared to the single bit embedding in each voice segment.

In the first step, the algorithm inspects the power of the speech signal in a sliding window and detects the pauses or unvoiced segments. Using these points as separators, speech is divided into continuous words or phrases. In this step, the chosen segments are not required to correspond to actual words, the requirement is that the algorithm be repeatable with sufficient accuracy. Once speech segments are isolated, pitch periods are determined. The pitch periods are then modified such that the average pitch period of each word/phase reflects a payload bit.

As indicated above, the payload information is embedded by a QIM scheme, which is known for its robustness against additive noise and favorable host signal interference cancellation properties. It has been experimentally determined that the average pitch period is a robust feature. Therefore, it is not necessary-yet still possible-to impose additional redundancy using projection based methods or spread spectrum techniques. In one embodiment, the present invention may utilize specific speech signal features associated with speech generation models for the embedding of watermark payload. These are incorporated and preserved in source-model based speech coders that are commonly employed for low data-rate (5-8 kbps) communication of speech. The method is therefore naturally robust against these coders and significantly advantageous in this regard over embedding methods designed for generic audio watermarking. The embedding capacity of this method, though relatively low, is sufficient for meta-data tagging and semi-fragile authentication applications, in which robustness against low data-rate compression is of particularly importance.

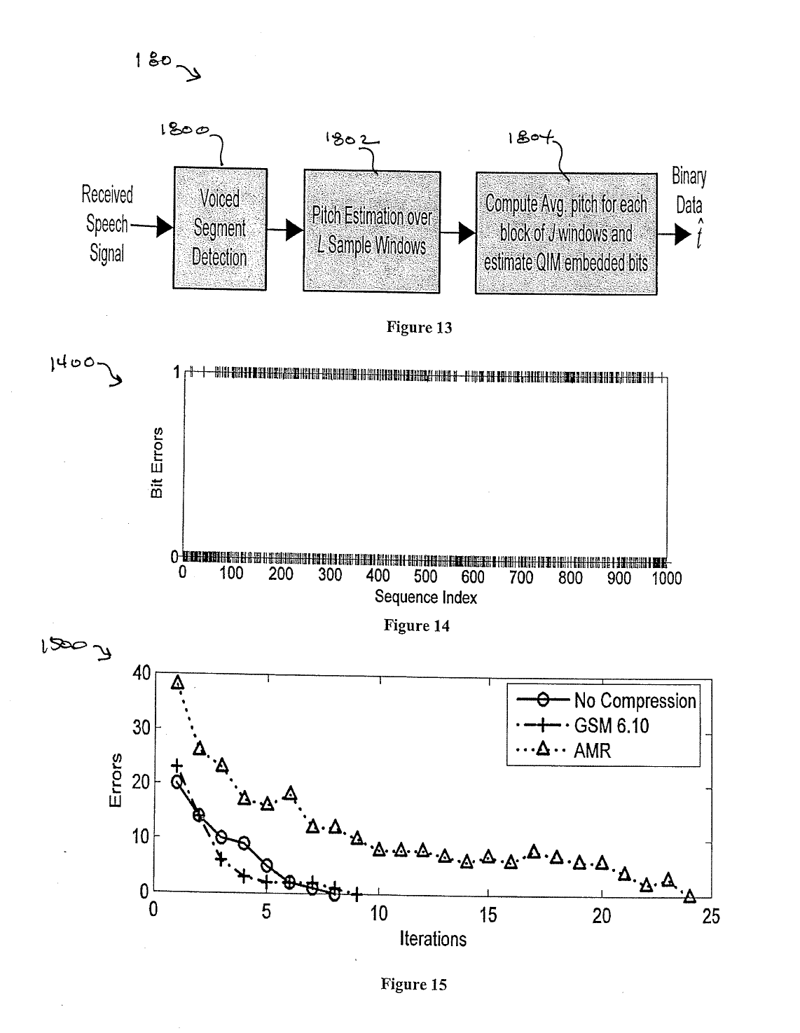

Referring to FIG. 13, an example implementation of the pitch extraction module 180 (depicted in FIG. 11) is disclosed. FIG. 13 provides one example of extracting data embedded in speech using pitch modification. At the receiver 16, the speech waveform is analyzed to detect voiced segments and pitch values are estimated for non-overlapping analysis windows of L samples each. In a process minoring the embedding operation, the average pitch values are computed over blocks of J contiguous analysis windows. For each block, an estimated value of the embedded bit is computed as the index 0/1 of the quantizer {Q_{b}( )}_{b=0}¹ that a reconstruction value closest to the average pitch. This provides an estimate of the embedded data.

FIG. 14 and FIG. 15 illustrate the performance of the present invention. In particular, the embodiment depicted in FIGS. 11-13 was implemented. In order to evaluate the performance of the present invention's synchronization method for multimedia data embedding based on signal feature modification, sample speech files from a database provided by NSA were used for the testing of speech compression algorithms. The files consist of continuous sentences read by both male and female speakers. For the q-ary LDPC code, an irregular binary parity check matrix H with column weight of 3 and coding rate of ¼ was generated. The columns of the matrix were assigned q-ary symbol values from the heuristically optimized sets made available by Mackay. A generator matrix for systematic encoding was obtained using Gaussian elimination. The marker vector w was generated using a pseudo-random number generator whose seed served as a shared key between the transmitter and receiver. Coarse estimates of the channel parameters were found by performing a sample pitch based embedding and extraction that was manually aligned (with help from the timing information) to determine the number of insertion, deletion, and substitution events. The mean density of sparse vectors was obtained from the sparse LUT and made available to the inner decoder for the forward-backward passes.

Random message vectors of q=16-ary message symbols were generated to test the performance of the system. The message vectors were arranged in blocks of K=25 and encoded as LDPC code vectors of length N=100. The length of the sparse vectors was chosen as n=10; resulting in an overall coding rate of 0.10. The binary data obtained from the sparsifier was embedded into the speech signal by QIM of the average pitch using a quantization step of Δ=10 ms.

The present invention was tested using three communication channel models. In the first case, the watermarked speech signal was unchanged between embedding and extraction. In the second case, the transmitted signal was directed into a GSM-06.10 (Global System for Mobile Communications, version 06.10) coder at 13 kbps. This codec is commonly used in today's second generation (2G) cellular networks that comply with GSM standard. In the third case, the speech signal traversed an AMR (Adaptive Multi-Rate) coder at 5.1 kbps. This codec has been standardized for third generation cellular networks (3 GPP standard).

In order to illustrate how synchronization loss occurs and how the method is able to regain synchronization, results are presented for a sample run of one block through the system. Where necessary, each q=16-ary message symbol is represented as log₂ q=4 binary digits.

FIG. 14 is a chart showing the differences between inserted and extracted bits in the absence of synchronization. The chart provides results derived from an system implemented using what is known as the PRAAT toolbox for the pitch manipulation operations, analysis and embedding, and MATLAB™ for the inner and outer decoding processes. The channel operations corresponding to various compressors were performed using separately available speech codecs. For the sparse look-up table (LUT) q=2^{k} vectors of length n were generated with the lowest possible density of 1's and ordered them sequentially to represent the q=2^{k} possible values for a codeword symbol. For computational efficiency in the message passing for the q-ary code we utilized a FFT method. FIG. 14 illustrates the differences between inserted bits t in the speech waveform and extracted bits \hat{t} where the status of 1000 embedded bits is indicated the “+” symbols at 0 along the y axis indicate locations where the embedded and extracted bits match and those at 1 indicate locations where they differ. As can be seen, in the initial segment there is reasonable agreement between the symbols but beyond that the agreement between the bits is no better than random. This is primarily due to a loss of synchronization between the embedded and extracted bit-streams—once synchronization is lost independent bits embedded at different locations are in fact being compared, which match with probability half.

Table I shows a comparison across the different “channels” that were previously enumerated.

TABLE 1
Comparison of error correction performance and decoder execution times over
different “channels”

| Channel | Bit Errors w/o | Errors after | LDPC Decoder | Inner Decoder | LDPC Decoder |
|---|---|---|---|---|---|
| (Compression) | Synchronization | Synchronization | Iterations | Execution Time | Execution Time |
| None | 464 | 0 | 8 | 195 s | 4.5 s |
| AMR | 313 | 0 | 24 | 347.7 s | 20.625 s |
| GSM | 441 | 0 | 9 | 192.3 s | 5.1 s |

The columns in the table list the initial error count, the number of errors after the decoding, and the computation requirements in terms of the number of LDPC iterations as well as the computation times spent by our (unoptimized) decoder in the inner and outer coders for the concatenated synchronization code. From the table one can note that in all cases the loss of synchronization produces a rather high apparent bit rate but the proposed method is able to handle the errors and recover the embedded data with no errors. In looking at the computation time, it is noted that the major computational load lies in the inner-decoder. The MATLAB based implementation is quite inefficient for the inherently serial computations required in this process and it is possible that the process could be considerably speeded up with an alternate implementation. However, given the nonlinear nature of the HMM-based decoder, a high computational load is to be expected. The table also illustrates that the most challenging of the channels is the extremely low-rate AMR compression which requires both a high computational time and the largest number of outer LDPC iterations.

FIG. 15 is a chart showing LDPC iteration count vs. the number of errors for the outer counter. The number of symbol errors as a function of LDPC iteration count is shown for each of the cases. The behavior of the iterative decoding for the outer LDPC decoder was examined. For the GSM codec, it is seen that, in the absence of compression, the number of errors rapidly falls achieving correct decoding in less than 10 iterations. On the other hand, for the AMR codec, a large number of iterations are necessary in order to correct all the errors.

While the present embodiment of the invention has been described utilizing an LDPC code as the outer code. It will be apparent to those of ordinary skill in the art that the outer code can alternately be replaced by other error correction codes capable of decoding based on “soft-inputs” in the form of probability vectors. Examples of such codes include turbo codes, repeat accumulate codes, other codes based on sparse graphs, and the like. These alternate embodiments of the present invention are all included within the scope of the present disclosure.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

The recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed.

No language in the specification should be construed as indicating any non-claimed element as essential to the practice of the invention.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention cover the modifications and variations of this invention provided they come within the scope of the appended claims and their equivalents.

What is claimed is:

1. A system comprising:
a signal feature estimator module configured to derive a plurality of signal feature estimate values from a received signal;
an inner symbol alignment decoder coupled to the signal feature estimator module, the inner symbol alignment decoder being configured to generate N probability vectors from the plurality of signal feature estimate values using a predetermined marker vector, N being an integer estimate of a number of symbols in a codeword corresponding to an watermark message that may or may not be embedded in the received signal; and
an outer soft-input error correction decoder coupled to the inner decoder, the outer decoder performing decoding of the received probabilities from the inner decoder in order to estimate the watermark message potentially embedded within the multimedia signal.

2. The system in claim 1, where in the outer decoder comprises an LDPC decoder and the decoder performs a series of iterative computations up to a predetermined number of iterations, each iterative computation generating an estimated watermark message based on the N probability vectors, the estimated watermark message being authenticated if and only if the estimated watermark message satisfies a low density parity check within the predetermined number of iterative computations.

3. The system of claim 2, further comprising at least one circuit configured to generate an alarm signal if the estimated watermark message does not satisfy the parity check within the predetermined number of iterative computations.

4. The system of claim 3, wherein the at least one circuit is coupled to an output device, the at least one circuit preventing the received signal from being directed to the output device if the estimated watermark message does not satisfy the parity check within the predetermined number of iterative computations.

5. The system of claim 3, wherein the at least one circuit allows the received signal to be directed to the output device if the estimated watermark message satisfies the parity check within the predetermined number of iterative computations.

6. The system of claim 1, wherein the estimator module is configured to detect received signal segments based on a signal feature, obtain a plurality of signal feature samples from each of the received signal segments, and process the plurality of signal feature samples to obtain the plurality of signal feature estimate values.

7. The system of claim 6, wherein the plurality of signal feature samples are averaged to obtain the plurality of signal feature estimate values.

8. The system of claim 6, wherein each estimated value is computed using a QIM demodulator.

9. The system of claim 1, wherein the inner decoder employs a hidden Markov model such that each of the N probability vectors is a probability mass function vector.

10. The system of claim 9, wherein the probability mass function vector is a function of a plurality of predetermined event probabilities.

11. The system of claim 10, wherein the plurality of predetermined event probabilities include a probability that a random bit is improperly inserted into the received signal, a probability that a bit in the received signal is correctly received, a probability that a validly transmitted bit is improperly deleted from the received signal, and a probability that a bit in the received signal is incorrectly received.

12. The system of claim 2, wherein the LDPC decoder estimates a marginal posterior probability for each tentative symbol value using a sum-product algorithm, a tentative symbol value being selected when the marginal posterior probability is at a maximum value.

13. The system of claim 12, wherein the LDPC decoder performs the parity check by multiplying the estimated watermark message by a LDPC parity check matrix (H), the estimated watermark message (x) including a plurality of tentative symbol values, the estimated watermark message satisfying the parity check if Hx equals zero (0).

14. The system of claim 1, wherein the received signal includes an audio signal.

15. The system of claim 1, wherein the received signal includes a speech signal.

16. The system of claim 1, wherein the received signal includes a video signal.

17. The system of claim 1, wherein the received signal includes music content.

18. The system of claim 1, wherein the received signal is a telephonic signal.

19. The system of claim 1, wherein the signal feature is pitch.

20. The system of claim 1, wherein the signal feature includes pseudo-periodic signal segments.

21. The system of claim 1, wherein the signal feature includes a video artifact.

22. The system of claim 1, further comprising a receiver coupled to the signal feature estimator module, the receiver being configured to derive the received signal from signals propagating in a communication channel.

23. The system of claim 22, wherein the communication channel propagates signals selected from a group of signals that includes electromagnetic signals and/or acoustic signals.

24. The system of claim 23, wherein the electromagnetic signals include RF signals, telephonic signals, baseband electrical signals, optical signals, and wherein the channel comprises wireless, fiber optic, optical, coaxial, line-of-sight, and/or wireline transmission media.

25. A multi-media system comprising:
a communication interface configured to be coupled to a network and configured to provide the received signal from the network;
the system of claim 1 coupled to the communications interface, the system of claim 1 being further configured to generate an error correction decoder output signal in accordance with the estimated watermark signal; and
a media device coupled to the system of claim 1 and the communication interface, the media device being configured to convert the received signal into a human perceptible output signal and/or provide a response in accordance with the error correction decoder output signal.

26. The multi-media system of claim 25, wherein the media device is selected from a group of media devices that includes a television, an audio system, an audio-visual system, a telephonic device, and/or a computing device.

27. A media player device comprising:
the system of claim 1 being further configured to generate an error correction decoder output signal in accordance with the estimated watermark signal; and
a reader mechanism coupled to the system of claim 1, the reader mechanism being configured to retrieve a digital file stored on a media element, the reader mechanism being further configured to convert the digital file into the received signal and/or provide a response in accordance with the error correction decoder output signal.

28. The system of claim 1, further comprising:
an outer coder configured to encode a watermark signal with an error correction code to generate a codeword having N symbols;
a sparsifier look-up table (LUT) coupled to the outer coder, the sparsifier LUT being configured to map each of the N-symbols to a memory location within the sparsifier LUT to obtain a sparse message vector;
an element configured to store the marker vector;
an adder coupled to the element and the sparsifier LUT, the adder being configured to combine the sparse message vector and the marker vector to generate an embedded message; and
a signal feature embedding module coupled to a media signal source and the adder, the signal feature embedding module being configured to detect media signal segments based on the signal feature and embed at least one bit of the embedded message into each media signal segment to thereby generate a watermarked media signal.

29. The system of claim 28, further comprising a transmitter coupled to the signal feature embedding module, the receiver being configured to transmit the watermarked media signal over a communication channel.

30. The system of claim 29, further comprising a mobile platform including at least one housing configured to accommodate the system.

31. The system of claim 30, wherein the mobile platform includes an aircraft.

32. The system of claim 30, wherein the mobile platform includes a ground based vehicle.

33. A system comprising:
a transmitter subsystem including,
an outer coder configured to encode a watermark signal with an error correction encoder to generate a codeword having N symbols,
a sparsifier look-up table (LUT) coupled to the outer coder, the sparsifier LUT being configured to map each of the N-symbols to a memory location within the sparsifier LUT to obtain a sparse message vector,
an adder coupled to the sparsifier LUT, the adder being configured to combine the sparse message vector and a marker vector to generate an embedded message, and
a signal feature embedding module coupled to a media signal source and the adder, the signal feature embedding module being configured to detect media signal segments based on the signal feature and embed at least one bit of the embedded message into each media signal segment to thereby generate a watermarked media signal; and
a receiver subsystem including,
a signal feature estimator module configured to derive a plurality of signal feature estimate values from a received signal,
an inner symbol alignment decoder coupled to the signal feature estimator module, the inner symbol alignment decoder being configured to generate N probability vectors from the plurality of signal feature estimate values using a predetermined marker vector, N being an integer estimate of a number of symbols in a codeword corresponding to an oblivious watermark message that may or may not be embedded in the received signal, and an outer soft-input error correction decoder coupled to the inner decoder, the outer decoder performing computations to obtain an estimated watermark message based on the N probability vectors.

34. The system of claim 33, further comprising a transmitter coupled to the signal feature embedding module, the receiver being configured to transmit the watermarked media signal over a communication channel.

35. The system of claim 34, further comprising a receiver coupled to the signal feature estimator module, the receiver being configured to derive the received signal from signals propagating in the communication channel.

36. The system of claim 35, wherein the transmitter sub-system is disposed at a first location and the receiver sub-system is disposed at a second location, the transmitter being linked to the receiver via the communication channel.
